(19) United States
(12) Patent Application Publication
(10) Pub. No.: US 2014/0092628 A1
(43) Pub. Date: Apr. 3, 2014

(54) ILLUMINATION DEVICE

(71) Applicants: Zhi-Ting Ye, Miaoli County (TW); Chia-Hung Pan, Taichung City (TW); Ming-Chuan Lin, Taichung City (TW); Hung-Pin Chang, Taichung City (TW); Wen-Chieh Wu, New Taipei City (TW)

(72) Inventors: Zhi-Ting Ye, Miaoli County (TW); Chia-Hung Pan, Taichung City (TW); Ming-Chuan Lin, Taichung City (TW); Hung-Pin Chang, Taichung City (TW); Wen-Chieh Wu, New Taipei City (TW)

(73) Assignee: WINTEK CORPORATION, Taichung City (TW)

(21) Appl. No.: 14/043,855

(22) Filed: Oct. 2, 2013

(30) Foreign Application Priority Data
Oct. 2, 2012 (TW) 101136405

(51) Int. Cl. F21V 8/00

(52) U.S. Cl. CPC G02B 6/0045
USPC 362/606; 362/611; 362/612

(57) ABSTRACT

An illumination device including a light guiding element, a light emitting element, and a reflective element is provided. The light guiding element has a light incident surface, a light emitting surface, a first surface and a second surface. The light incident surface surrounds the light guiding element and is connected between the light emitting surface and the first surface. The first surface is connected between the light incident surface and the second surface so that the second surface is substantially opposite to the light incident surface. The second surface constructs a depression structure having a diameter gradually changed from the first surface towards the light emitting surface. The light emitting element surrounds the light guiding element to emit a light towards the light incident surface. The reflective element is disposed at least on the first surface.

### CROSS-REFERENCE TO RELATED APPLICATION

This application claims the priority benefit of Taiwan application serial no. 101136405, filed on Oct. 2, 2012. The entirety of the above-mentioned patent application is hereby incorporated by reference herein and made a part of this specification.

### BACKGROUND

1. Technical Field

The invention relates to an illumination device. Particularly, the invention relates to an illumination device having a light guiding element.

2. Related Art

A light source module using a light emitting device in collaboration with a light guiding element has been widely used in an illumination field. Generally, after a light beam provided by the light emitting device enters the light guiding element, it is propagated therein, and emits from a light emitting surface of the light guiding element to form a required illumination light source.

In recent years, along with progress of illumination technology, the light source module has been gradually applied in many illumination devices. In various light emitting devices, light emitting diodes (LEDs) become a main stream due to its advantages of high luminance, low power consumption and low pollution.

In the conventional illumination device, after the light beam provided by the light emitting device enters the light guiding element through an incident surface of the light guiding element, the light beam emits out of the light guiding element through the light emitting surface. Therefore, a design of the light guiding element significantly influences a light emitting effect of the whole illumination device.

### SUMMARY

The invention is directed to an illumination device, having ideal light emitting efficiency.

The invention provides an illumination device including a light guiding element, a light emitting element and a reflective element. The light guiding element has a light incident surface, a light emitting surface, a first surface and a second surface. The light incident surface surrounds the light guiding element and is connected between the light emitting surface and the first surface. The first surface is connected between the light incident surface and the second surface so that the second surface is substantially opposite to the light incident surface, where the second surface constructs a depression structure. A diameter of the depression structure gradually changes from the first surface towards the light emitting surface. The light emitting element surrounds the light guiding element to emit a light towards the light incident surface. The reflective element is disposed at least on the first surface.

In an embodiment of the invention, the light guiding element has a dish-like shape.

In an embodiment of the invention, the reflective element is a diffusion type reflection layer.

In an embodiment of the invention, the depression structure penetrates through the light guiding element.

In an embodiment of the invention, the depression structure is located at a center of the light guiding element.

In an embodiment of the invention, the light emitting element includes a plurality of light emitting diodes (LEDs), and the LEDs surround the light incident surface.

In an embodiment of the invention, the illumination device further includes a first casing and a second casing. The light emitting element and the light guiding element configured with the reflective element are disposed between the first casing and the second casing to expose the light emitting surface of the light guiding element.

In an embodiment of the invention, the second surface is not parallel to the light incident surface.

In an embodiment of the invention, the reflective element is further disposed on the second surface.

In an embodiment of the invention, an intersection angle between the first surface and the second surface is from 130 degrees to 140 degrees.

In an embodiment of the invention, the light guiding element further includes a third surface connected between the first surface and the light incident surface, and the third surface and the first surface are intersected to form an obtuse angle. The reflective element is further disposed on the third surface. Moreover, the obtuse angle is from 165 degrees to 170 degrees.

According to the above descriptions, the depression structure is configured in the light guiding element, and the surface defining the depression structure is opposite to the light incident surface. Moreover, the surface of the depression structure is substantially unparallel to the light incident surface, which avails guiding the light entering the light guiding element to the light emitting surface to emit out of the illumination device. In this way, the illumination device of the invention has ideal light emitting efficiency.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an illumination device according to an embodiment of the invention.

FIG. 2 is a cross-sectional view of the illumination device of FIG. 1 along a section line I-I′.

FIG. 3 is a cross-sectional view of an illumination apparatus according to another embodiment.

FIG. 4 is a schematic diagram of an illumination device according to still another embodiment of the invention.

FIG. 5 is a cross-sectional view of the illumination device of FIG. 4 along a section line II-II′.

FIG. 6 is a cross-sectional view of an illumination device according to yet another embodiment of the invention.

FIG. 7 is a cross-sectional view of an illumination device according to still another embodiment of the invention.

FIG. 8 is a cross-sectional view of an illumination device according to still another embodiment of the invention.

FIG. 9 is a cross-sectional view of an illumination device according to still another embodiment of the invention.

### DETAILED DESCRIPTION OF DISCLOSED EMBODIMENTS

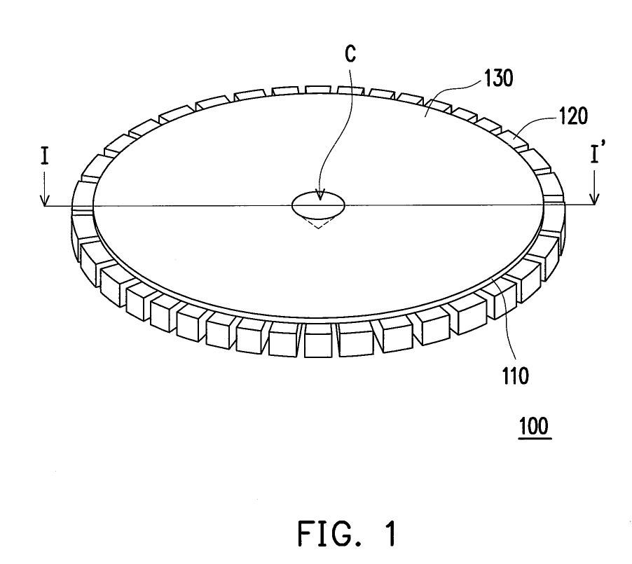

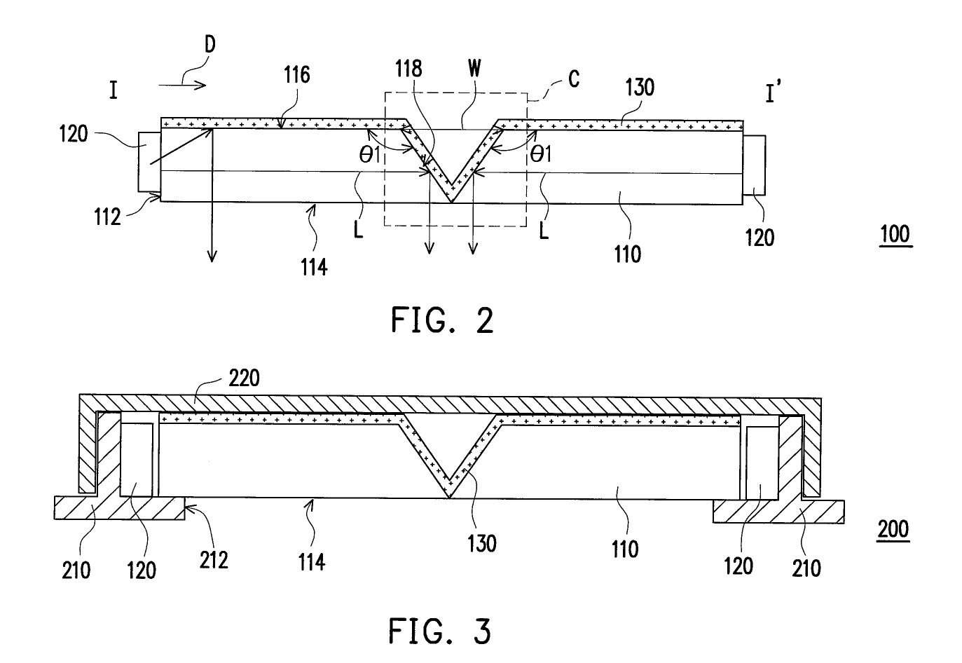

FIG. 1 is a schematic diagram of an illumination device according to an embodiment of the invention, and FIG. 2 is a cross-sectional view of the illumination device of FIG. 1 along a section line I-I′. Referring to FIG. 1 and FIG. 2, the illumination device 100 includes a light guiding element 110, a light emitting element 120 and a reflective element 130. The light guiding element 110 has a light incident surface 112, a light emitting surface 114, a first surface 116 and a second surface 118. The light incident surface 112 surrounds the light guiding element 110 and is connected between the light emitting surface 114 and the first surface 116. The first surface 116 is connected between the light incident surface 112 and the second surface 118. Now, the second surface 118 and the light incident surface 112 are located at two sides of the first surface 116 and located opposite to each other.

The light emitting element 120 surrounds the light guiding element 110, and the reflective element 130 is disposed on the first surface 116 and the second surface 118. In this way, the light emitting element 120 can emit a light L towards the light incident surface 112. Guided by the light guiding element 110 and reflected by the reflective element 130, the light L emits out of the illumination device 100 through the light emitting surface 114. In the present embodiment, the light emitting element 120 can be composed of a plurality of light emitting diodes (LEDs) surrounding the light guiding element 110, and the reflective element 130 can be a diffusion type white reflective ink layer coated on the first surface 116 and the second surface 118. However, the invention is not limited thereto, and in other embodiments, the light emitting element 120 can be composed of an annular lamp, and the reflective element 130 can be selectively an element composed of other diffusion type reflective material.

Since when the light L emitted from the light emitting element 120 irradiates the light incident surface 112, the light L is approximately propagated along a direction D, after the light L enters the light guiding element 110, a part of the light L is continually propagated along the direction D to penetrate through the light guiding element 110. In this way, such part of the light L cannot emit out from the light emitting surface 114, and becomes a light source that cannot be used. In other words, such propagating path leads to poor light emitting efficiency of the illumination device 100. Therefore, in the light guiding element 110 of the present embodiment, the second surface 118 substantially opposite to the light incident surface 112 is configured to ameliorate the light emitting efficiency of the illumination device.

In detail, the second surface 118, for example, constructs a depression structure C in the light guiding element 110, where the depression structure C can be located at a center of the light guiding element 110. A diameter W of the depression structure C gradually decreases from the first surface 116 towards the light emitting surface 114. In this way, the second surface 118 and the light incident surface 112 are substantially opposite to each other and are not parallel to each other. When the light L is propagated in internal of the light guiding element 110 along the direction D to reach the second surface 118, the light L is reflected by the reflective element 130 disposed on the second surface 118. Now, due to an inclining direction of the second surface 118, the reflected light L emits out of the illumination device 100 through the light emitting surface 114, which improves the light emitting efficiency of the illumination apparatus 100.

In the present embodiment, a material of the light guiding element 110 is, for example, polymethyl methacrylate (PMMA), polycarbonate (PC) or glass, though the invention is not limited thereto. Refractive indexes of these materials are all greater than that of external (a refractive index of air). Once an incident angle of the light L incident to the second surface 118 is greater than a total reflection threshold, the light L is totally reflected on the second surface 118 and propagated towards the light emitting surface 114. Therefore, in other embodiments, it can be selected not to dispose the reflective element 130 on the second surface 118, and the inclining angle of the second surface 118 can be further adjusted, selectively. In case of such structure, if the incident angle of a part of the light L that cannot reach the reflective element 130 disposed on the first surface 116 is greater than the total reflection threshold, the part of light L that irradiates the second surface 118 can be totally reflected by the second surface 118 to emit out through the light emitting surface 114. In the present embodiment, when the second surface 118 is configured with the reflective element 130, a high light emitting efficiency is achieved, and when the second surface 118 is not configured with the reflective element 130, a bright ring phenomenon caused by a reflection function of reflecting the light L at the second surface 118 is mitigated. In the present embodiment, in order to improve a ratio that the light L emits out through the light emitting surface 114, an intersection angle θ1 between the first surface 116 and the second surface 118 is from 130 degrees to 140 degrees. Certainly, the above value is only an example, and in other embodiments, the intersection angle θ1 between the first surface 116 and the second surface 118 can be determined according to the material of the light guiding element 110.

FIG. 3 is a cross-sectional view of an illumination apparatus according to another embodiment. Referring to FIG. 3, besides the light guiding element 110, the light emitting element 120, and the reflective element 130 illustrated in FIG. 1 and FIG. 2, the illumination apparatus 200 further includes a first casing 210 and a second casing 220. The first casing 210 has an opening 212, and the light emitting element 120 and the light guiding element 110 configured with the reflective element 130 are disposed and fixed between the first casing 210 and the second casing 220. Now, the opening 212 of the first casing 210 exposes the light emitting surface 114 of the light guiding element 110. Moreover, after the illumination device 200 is assembled, the reflective element 130 is located between the light guiding element 110 and the second casing 220. The first casing 210 and the second casing 220 can be combined though a buckled on a mechanism or through locking of a locking member. Moreover, in other embodiments, the first casing 210 and the second casing 220 can be replaced by a single casing, or can be implemented by a plurality of members.

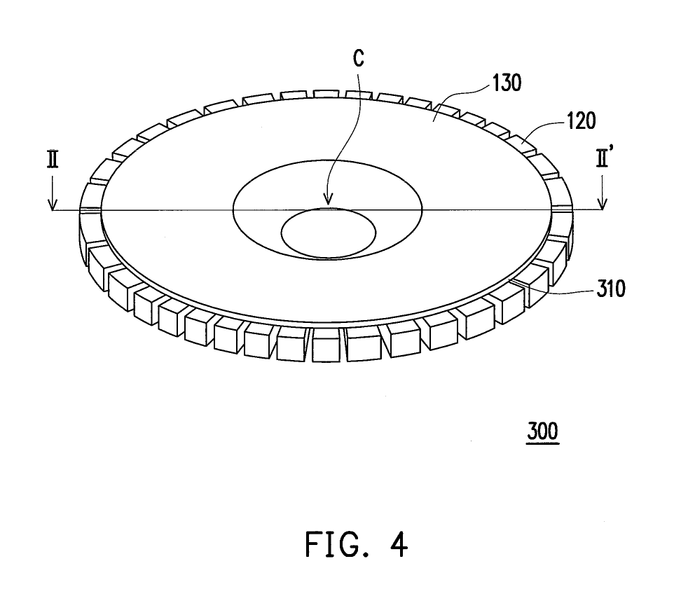

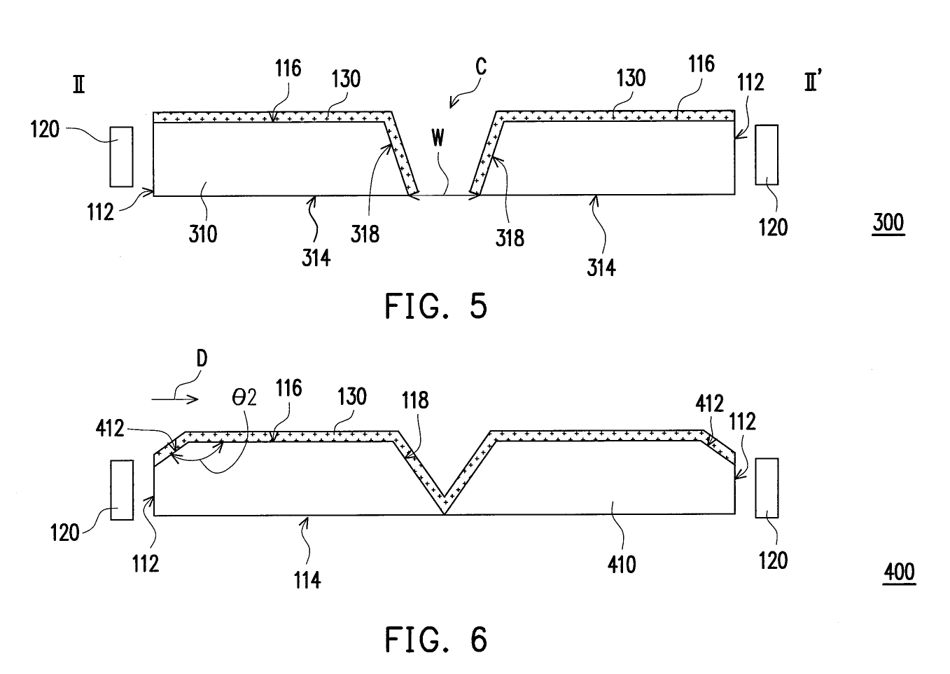

FIG. 4 is a schematic diagram of an illumination device according to still another embodiment of the invention, and FIG. 5 is a cross-sectional view of the illumination device of FIG. 4 along a section line II-II′. Referring to FIG. 4 and FIG. 5, the illumination device 300 includes a light guiding element 310, a light emitting element 120 and a reflective element 130. In detail, the illumination device 300 is similar to the illumination device 100, and a main difference there between lies in a design of the light guiding element 310. Therefore, the design of the light guiding element 310 is mainly described below.

The light guiding element 310 has a light incident surface 112, a light emitting surface 314, a first surface 116 and a second surface 318. The light incident surface 112 surrounds the light guiding element 110 and is connected between the light emitting surface 314 and the first surface 116. The first surface 116 is connected between the light incident surface 112 and the second surface 318. Now, the second surface 318 and the light incident surface 112 are located at two sides of the first surface 116 and located opposite to each other. Moreover, the second surface 318, for example, constructs a depression structure C in the light guiding element 310, where a diameter W of the depression structure C gradually decreases from the first surface 116 towards the light emitting surface 314, and in the present embodiment, the depression structure C substantially penetrates through the light guiding element 310. Now, the light emitting surface 314 has an opening corresponding to the diameter W. Namely, in the present embodiment, both of centers of the first surface 116 and the light emitting surface 314 have openings to present an annular pattern. Certainly, in other embodiments, it can be selected not to dispose the reflective element 130 on the second surface 318, and the inclining angle of the second surface 318 can be further adjusted, selectively.

When a light emitting effect of the illumination device is simulated, it is discovered that the light emitting efficiency of the illumination device is about 59.6% when the light guiding element therein is not configured with the depression structure of FIG. 1 or FIG. 4. When the light guiding element has the depression structure of FIG. 1, the light emitting efficiency of the illumination device is about 67.25%. Moreover, when the light guiding element has the depression structure of FIG. 4, the light emitting efficiency of the illumination device is about 74.6%. Therefore, according to the simulation result, it is known that the depression structure formed by the second surface in the aforementioned embodiment can effectively improve the light emitting efficiency of the illumination device. However, in order to achieve ideal light emitting efficiency and light emitting quality, the light guiding element of the invention is not limited to the aforementioned structures.

FIG. 6 is a cross-sectional view of an illumination device according to yet another embodiment of the invention. Referring to FIG. 6, the illumination device 400 is substantially similar to the illumination device 100, and the like and the same elements in the two embodiments are indicated by the like and the same reference numerals throughout, and thus descriptions thereof are not repeated. The illumination device 400 includes a light guiding element 410, a light emitting device 120 and a reflective element 130. The light guiding element 410 has a light incident surface 112, a light emitting surface 114, a first surface 116, a second surface 118 and a third surface 412. Moreover, the second surface 118, for example, constructs a depression structure C in the light guiding element 410.

The light incident surface 112 surrounds the light guiding element 110 and is connected between the light emitting surface 114 and the first surface 116. The first surface 116 is connected between the light incident surface 112 and the second surface 118, and the third surface 412 is located between the first surface 116 and the light incident surface 112. Now, the second surface 118 and the light incident surface 112 are located opposite to each other. Moreover, the third surface 412 and the light emitting surface 114 are substantially located at two opposite sides of the light incident surface 112. In an embodiment, an intersection angle θ2 between the third surface 412 and the first surface 116 can be an obtuse angle, which is, for example from 165 degrees to 170 degrees.

The light L emitted from the light emitting element 120 is mainly propagated along the direction D. However, a part of the light L may deviate from the propagating direction along the direction D, and irradiates the third surface 412. In the present embodiment, as the third surface 412 is a gently inclined surface due to the design of the angle θ2, the incident angle of the light L at the third surface 412 is increased such that an opportunity of totally reflection of the light L is increased. Now, the light L totally reflected by the third surface 412 can emit out of the light guiding element 410 at a position farther away from the light incident surface 112. In this way, a light emitting uniformity of the illumination device 400 is further improved. Moreover, the reflective element 130 can be selectively extended to the third surface 412 to improve the light emitting efficiency of the illumination device 400.

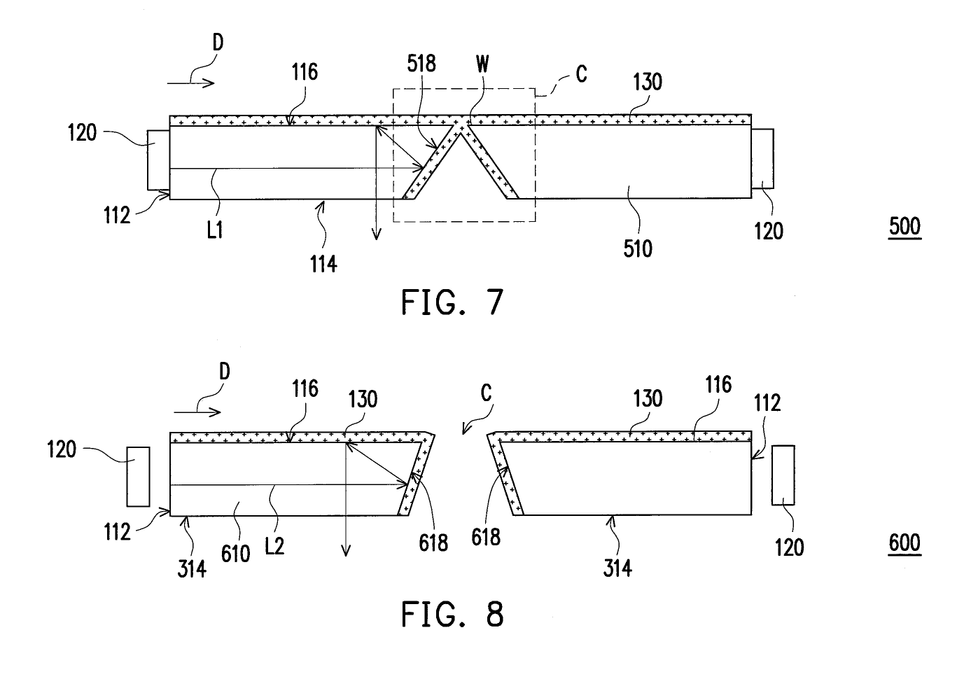

In the aforementioned embodiments, the diameter W of the depression structure C all gradually decreases from the first surface towards the light emitting surface, though the invention is not limited thereto. FIG. 7 is a cross-sectional view of an illumination device according to still another embodiment of the invention. Referring to FIG. 7, the illumination device 500 is substantially similar to the illumination device 100 of FIG. 1, and the like and the same elements in the two embodiments are indicated by the like and the same reference numerals throughout, and thus descriptions thereof are not repeated. A main difference between the present embodiment and the illumination device 100 lies in the design of the depression structure C of the light guiding element 510. Therefore, the design of the depression structure is mainly described below.

The diameter W of the depression structure C gradually increases from the first surface 116 towards the light emitting surface 114. In this way, a second surface 518 and the light incident surface 112 are substantially opposite to each other and are not parallel to each other. When the light L is propagated in internal of the light guiding element 510 along the direction D to reach the second surface 518, the light L is reflected by the reflective element 130 disposed on the second surface 518. Now, due to an inclining direction of the second surface 518, the reflected light L is first propagated to the first surface 116, and is further reflected by the reflective element 130 on the first surface 116, and emits out of the illumination device 500 through the light emitting surface 114, so as to improve the light emitting efficiency of the illumination device 500.

FIG. 8 is a cross-sectional view of an illumination device according to still another embodiment of the invention. Referring to FIG. 8, the illumination device 600 is substantially similar to the illumination device 300 of FIG. 4, and the like and the same elements in the two embodiments are indicated by the like and the same reference numerals throughout, and thus descriptions thereof are not repeated. A main difference between the present embodiment and the illumination device 100 lies in the design of the depression structure C of the light guiding element 610. Therefore, the design of the depression structure is mainly described below.

The diameter of the depression structure C gradually increases from the first surface 116 towards the light emitting surface 314, and the depression structure C substantially penetrates through the light guiding element 610. Now, the light emitting surface 314 has an opening corresponding to the diameter W. Similarly, when the light L2 is propagated in internal of the light guiding element 610 along the direction D to reach the second surface 618, the light L2 is reflected by the reflective element 130 disposed on the second surface 618. Now, due to an inclining direction of the second surface 618, the reflected light L2 is first propagated to the first surface 116, and is further reflected by the reflective element 130 on the first surface 116, and emits out of the illumination device 600 through the light emitting surface 314, so as to improve the light emitting efficiency of the illumination device 600.

Certainly, in the embodiments of FIG. 7 and FIG. 8, it can be selected not to dispose the reflective element 130 on the second surfaces 518 and 618, and through total reflections of the lights L1 and L2 on the second surfaces 518 and 618, at least a part of the lights L1 and L2 is reflected to the first surface 116, and is further reflected by the reflective element 130 on the first surface 116 to emit out of the illumination devices 500 and 600 through the light emitting surfaces 114 and 314.

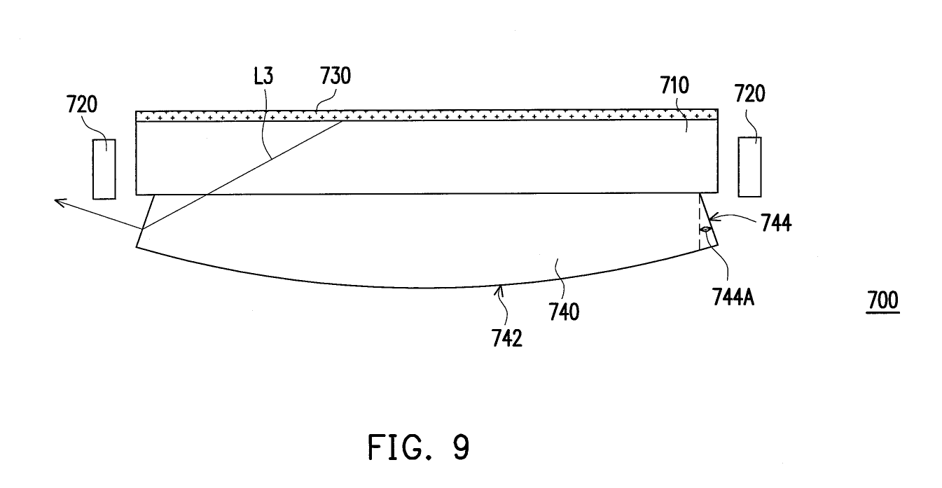

FIG. 9 is a cross-sectional view of an illumination device according to still another embodiment of the invention. Referring to FIG. 9, the illumination device 700 includes a light guiding element 710, a light emitting element 720, a reflective element 730 and a secondary optical element 740. The secondary optical element 740 is disposed in front of the light emitting surface of the light guiding element 710. In the present embodiment, structures, materials and a configuration relationship of the light guiding element 710, the light emitting element 720 and the reflective element 730 can refer to the design of any of the illumination devices 100-600 in the aforementioned embodiments, which are not repeated. In detail, the present embodiment can be regarded as an implementation of configuring the secondary optical element 740 in front of the light emitting surface of any one of the illumination devices 100-600 in the aforementioned embodiments.

The secondary optical element 740 of the present embodiment is, for example, a lens, which has a first light emitting surface 742 and a second light emitting surface 744, where the second light emitting surface 744 is located between a light emitting surface of a light guiding element 710 and the first light emitting surface 742. When a normal line of the light emitting surface of the light guiding element 710 is taken as a reference direction, an included angle 744A between the second light emitting surface 744 and the reference direction is about 30 degrees to 45 degrees. Moreover, the first light emitting surface 742 can be an arc surface, and a radius of curvature thereof is preferably 100 mm-2,000 mm. In this way, a part of the light, for example, the light L3 emits out from the second light emitting surface 744 due to a refraction function of the secondary optical device 740, and another part of the light is first reflected by the first light emitting surface 742 and emits out from the second light emitting surface 744.

If the illumination device 700 is installed on a ceiling, the part of light emitted from the second light emitting surface 744 can irradiate the originally dark part of the ceiling to form a halo thereon, which may create a different sense of space and achieve a decoration effect.

In summary, in the illumination device of the invention, the light emitting device is disposed to surround the light guiding element, and the depression structure is disposed at the center of the light guiding element. When the diameter of the depression structure is set to be gradually changed towards the light emitting surface, the light emitted from the light emitting element can be reflected by the depression structure to reach the light emitting surface or rebound to the reflective element opposite to the light emitting surface. In this way, the light emitted from the light emitting element has a high ratio to emit out of the light guiding element through the light emitting surface, which improves the light emitting efficiency of the illumination device.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An illumination device, comprising:
a light guiding element, having a light incident surface, a light emitting surface, a first surface and a second surface, the light incident surface surrounding the light guiding element and being connected between the light emitting surface and the first surface, and the first surface is connected between the light incident surface and the second surface so that the second surface is substantially opposite to the light incident surface, wherein the second surface constructs a depression structure, and a diameter of the depression structure gradually changes from the first surface towards the light emitting surface;
a light emitting element, surrounding the light guiding element to emit a light towards the light incident surface; and
a reflective element, disposed at least on the first surface.

2. The illumination device as claimed in claim 1, wherein the light guiding element has a dish-like shape.

3. The illumination device as claimed in claim 1, wherein the reflective element is a diffusion type reflection layer.

4. The illumination device as claimed in claim 1, wherein the depression structure penetrates through the light guiding element.

5. The illumination device as claimed in claim 1, wherein the depression structure is located at a center of the light guiding element.

6. The illumination device as claimed in claim 1, wherein the light emitting element comprises a plurality of light emitting diodes, and the light emitting diodes surround the light incident surface.

7. The illumination device as claimed in claim 1, further comprising a first casing and a second casing, wherein the light emitting element and the light guiding element configured with the reflective element are disposed between the first casing and the second casing to expose the light emitting surface of the light guiding element.

8. The illumination device as claimed in claim 1, wherein the second surface is not parallel to the light incident surface.

9. The illumination device as claimed in claim 1, wherein the reflective element is further disposed on the second surface.

10. The illumination device as claimed in claim 9, wherein an intersection angle between the first surface and the second surface is from 130 degrees to 140 degrees.

11. The illumination device as claimed in claim 1, wherein the light guiding element further comprises a third surface connected between the first surface and the light incident surface, and the third surface and the first surface are intersected to form an obtuse angle.

12. The illumination device as claimed in claim 11, wherein the reflective element is further disposed on the third surface.

13. The illumination device as claimed in claim 11, wherein the obtuse angle is from 165 degrees to 170 degrees.

14. The illumination device as claimed in claim 1, wherein the diameter of the depression structure gradually increases from the first surface towards the light emitting surface.

15. The illumination device as claimed in claim 1, wherein the diameter of the depression structure gradually decreases from the first surface towards the light emitting surface.

16. The illumination device as claimed in claim 1, further comprising a secondary optical element disposed in front of the light emitting surface of the light guiding element, wherein the secondary optical element has a first light emitting surface and a second light emitting surface, and the second light emitting surface is located between the first light emitting surface and the light emitting surface of the light guiding element.

17. The illumination device as claimed in claim 16, wherein when a normal line of the light emitting surface of the light guiding element is taken as a reference direction, an included angle between the second light emitting surface and the reference direction is from 30 degrees to 45 degrees.

18. The illumination device as claimed in claim 16, wherein the first light emitting surface is an arc surface.

19. The illumination device as claimed in claim 18, wherein a radius of curvature of the arc surface is from 100 mm to 2,000 mm.
